(19) United States
(12) Patent Application Publication
(10) Pub. No.: US 2024/0405790 A1
(43) Pub. Date: Dec. 5, 2024

(54) V2X Vehicle-mounted Terminal Construction Method

(71) Applicant: Xiamen King Long United Automotive Industry Co., Ltd., Xiamen City (CN)

(72) Inventors: Jin Jiang, Xiamen City (CN); Cheng Wang, Xiamen City (CN); Caifeng Luo, Xiamen City (CN); Liang Su, Xiamen City (CN); Zhijun Liu, Xiamen City (CN)

(21) Appl. No.: 18/798,870

(22) Filed: Aug. 9, 2024

(30) Foreign Application Priority Data
Jul. 3, 2024 (CN) 2024108841865

(51) Int. Cl. H04B 1/3822; B60R 16/023; H04B 1/40; H04W 4/44

(52) U.S. Cl. CPC H04B 1/3822; B60R 16/0231; H04B 1/40; H04W 4/44

(57) ABSTRACT

The present invention relates to a V2X vehicle-mounted terminal construction method, which includes the following steps: S1: defining a product requirement and an external setting interface requirement of the vehicle-mounted terminal; S2. selecting the main control unit based on the product requirement and the external setting interface requirement; S3. selecting the communication module based on the product requirement; S4. selecting the security chip module based on the product requirement; S5: selecting the power management module based on a power supply requirement and an interface requirement of the main control unit, the communication module and the security chip module selected; and S6: performing circuit construction and optimization based on the selection results to complete the construction of the vehicle-mounted terminal hardware system. The construction method can carry out customized matching construction of the different types of vehicle-mounted terminal hardware systems, thereby accelerating the vehicle to realize intelligence, networking and informatization.

### BACKGROUND OF THE PRESENT INVENTION

### Field of Invention

The present invention relates to the technical field of smart network-connected automobiles, and in particular to a V2X vehicle-mounted terminal construction method.

### Description of Related Arts

In recent years, with the technological revolution, the development of 5G, communication protocols, roadside sensors, and vehicle-mounted terminals has accelerated the development of smart transportation. The deployment of vehicle-mounted terminals is a key link for the industrial application and landing of smart transportation. The functions of vehicle-mounted terminals are also gradually improving. Smart vehicle-mounted terminals can be equipped with rich functional application scenarios such as collision warning, blind spot/lane change reminder, road hazard reminder, road incident reminder, speed guidance, red light warning, perception sharing, collaborative lane change, etc., and can provide vehicle-road collaborative application support for assisted driving and advanced autonomous driving. In combination with the smart platform, the real-time speed of the vehicle can be planned in real time through the cloud control platform. In combination with the collaborative control of traffic lights, the accurate arrival of smart network-connected vehicles can be achieved. In combination with vehicle-road-cloud-map-network to realize full participation of transportation elements, monitor and command the urban transportation system from a god's-eye view perspective, and improve the service quality of public transportation and private driving.

Currently, vehicle-mounted terminals on the market are still in their infancy and cannot meet the increasing demand for intelligent networked vehicle functions. There are common problems such as fixed scenes, single functions, delayed data collection and packet loss, poor scalability, anti-interference, etc., which pose challenges in terms of security and reliability.

### SUMMARY OF THE PRESENT INVENTION

The present invention provides a V2X vehicle-mounted terminal construction method, whose main purpose is to overcome the problems of insufficient safety and reliability of the conventional vehicle-mounted terminals.

The present invention adopts the following technical solutions:

A V2X vehicle-mounted terminal construction method, wherein a vehicle-mounted terminal hardware system includes a main control unit, a communication module, a power management module and a security chip module, respectively arranged thereon, wherein
(1) the main control unit is used to process the relevant communication protocols to realize an information interaction between the vehicle and the outside world, and is also used to receive and process a vehicle data and control a working status of a vehicle-mounted terminal, wherein the vehicle data includes a whole vehicle controller information and a vehicle sensing equipment information;
(2) the communication module is used to integrate the vehicle data, a positioning data and a satellite time obtained in real time into a vehicle information and send the vehicle information to the outside world, and is also used to receive a comprehensive information from the outside world and send the comprehensive information to the main control unit, wherein the comprehensive information includes an information from other vehicles, infrastructure, pedestrians and network equipment;
(3) the power management module is used to control a power management of the vehicle-mounted terminal and control a sleep and wake-up of the vehicle-mounted terminal;
(4) the security chip module is used to encrypt and decrypt a communication data and perform a security certification on the communication equipment, thereby ensuring the security of a vehicle communication and data;
the construction method includes the following steps:
S1: defining a product requirement and an external setting interface requirement of the vehicle-mounted terminal;
S2. selecting the main control unit based on the product requirement and the external setting interface requirement determined in step S1;
S3. selecting the communication module based on the product requirement determined in step S1;
S4. selecting the security chip module based on the product requirement determined in step S1;
S5: selecting the power management module based on a power supply requirement and an interface requirement of the main control unit, the communication module and the security chip module selected in steps S2-S4; and
S6: performing circuit construction and optimization based on the selection results in steps S2 to S5 to complete the construction of the vehicle-mounted terminal hardware system.

Further, the communication module is a 5G/C-V2X module, wherein the 5G/C-V2X module includes an LTE-V2X radio frequency circuit to realize the information interaction with other vehicles, infrastructure and pedestrians, and a 5G radio frequency circuit to realize the information interaction with network equipment.

Further, the main control unit includes an MCU module and an AP module interconnected, wherein

the work content of the MCU module includes obtaining the vehicle data from a CAN bus network, communicating with a whole vehicle controller and the power management module to control the working states of the entire vehicle-mounted terminal and processing the vehicle data, the positioning data, and a specific external setting information, wherein

the work content of the AP module includes providing an access path for a C-V2X application layer to enhance security and efficiency and serving as a forwarding channel for the relevant communication protocols to optimize the communication performance with the communication module.

Further, the SPI pin of the communication module is connected and communicated with the SPI pin of the MCU module, which is used to transmit the CAN data information, wherein the USB pin of the communication module is connected and communicated with the USB pin of the AP module, which is used to transmit the V2X data information, wherein the SPI pin of the AP module is connected and communicated with the SPI pin of the security chip module, which is used to transmit the encrypted protocol data, wherein the SPI pin of the AP module is connected and communicated with the SPI pin of the MCU module, which is used to transmit the CAN data information, wherein the UART pin of the AP module is connected and communicated with the SPI pin of the MCU module, which is used to transmit the sleep and wake-up state information.

Further, the vehicle-mounted terminal hardware system further includes a clock module and a positioning module, wherein the clock module is electrically connected with the MCU module to provide the satellite time for the MCU module, wherein the positioning module is electrically connected with the communication module to provide the positioning data for the communication module.

Further, the AP module has a first EMMC memory, a DDR memory, an SDMMC pin for external connection to a memory card, a USB-HOST pin for burning the program, and a first Ethernet pin for debugging the network, respectively arranged thereon.

Further, the communication module has a second EMMC memory and a second Ethernet pin for debugging the network, respectively arranged thereon.

Further, the MCU module selects the S32K144HFT0VLLT chip, and the AP module selects the AG215S chip.

Further, the communication module selects the AG57XQ chip.

Further, the security chip module uses the XDSM3276 chip.

Compared with the conventional technology, the beneficial effect of the present invention is that:

the construction method provided by the present invention can carry out customized matching construction of the different types of vehicle-mounted terminal hardware systems, thereby achieving large-scale rapid development, accelerating the vehicle to realize intelligence, networking and informatization, having the advantages of good compatibility, high flexibility, miniaturization, high-performance, low energy consumption and low cost, and can effectively be overcoming the shortcomings of conventional technologies.

### BRIEF DESCRIPTION OF THE DRAWINGS

FIG. 1 is a block diagram of the hardware system of the present invention.

FIG. 2 is an architecture diagram of the hardware system of the present invention.

FIG. 3 is a control flow diagram of the present invention.

FIG. 4 is a circuit diagram of the MCU module of the present invention.

FIG. 5 is a circuit diagram of the communication module of the present invention.

FIG. 6 is a circuit diagram of the power management module of the present invention.

FIG. 7 is a circuit diagram of the security chip module of the present invention.

### DETAILED DESCRIPTION OF THE PREFERRED EMBODIMENT

Specific embodiments of the present invention are described below with reference to the accompanying drawings. In order to fully understand the present invention, many details are described below. However, for those skilled in the art, the present invention can be implemented without these details.

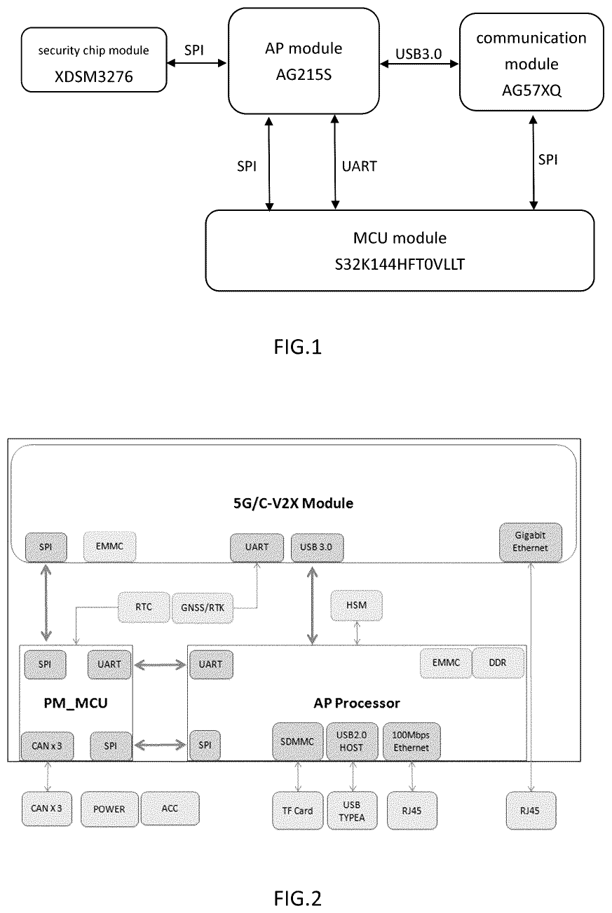

Referring to FIGS. 1 and 2, in order to solve the technical barriers faced by conventional vehicle-mounted terminals, the present invention proposes a V2X vehicle-mounted terminal construction method. This construction method divides the vehicle-mounted terminal hardware system into four core parts: main control unit, communication module, power management module and security chip module. Based on this construction method, a customized matching design of the hardware system of different types of vehicle-mounted terminals can be realized to achieve large-scale rapid development and accelerate the intelligence, interconnection, and informatization of vehicles.

First, the construction concepts of each core part are introduced in detail:

### 1. Main Control Unit

Referring to FIGS. 1 and 2, the main control unit is responsible for processing the relevant communication protocols to realize the information interaction between the vehicle and the outside world, and is also responsible for receiving and processing the vehicle data, and controlling the working states of the vehicle-mounted terminal.

Specifically, the main control unit needs to process various relevant communication protocols, such as TCP/IP, HTTP, MQTT, etc., to realize the information interaction between the vehicle and the outside world, and is also responsible for collecting and processing the vehicle data, which can be used for functions such as vehicle control, fault diagnosis and driving assistance after processing. In addition, the main control unit module is also responsible for controlling the working status of the vehicle-mounted terminal, so that it can run various applications, such as navigation, entertainment, remote control, etc., which can improve the driving experience and the level of vehicle intelligence.

The vehicle data includes a whole vehicle controller information and a vehicle sensing equipment information, wherein the whole vehicle controller information includes a braking system status information, a wheel rotation angle information, an accelerator pedal information, a current gear information and other data from various systems of the vehicle, while the vehicle sensing equipment information includes a millimeter wave radar information, a laser radar information, an ultrasonic radar information and a visual camera information. The main control unit needs to send the collected vehicle data to the communication module in real time, and the information is integrated by the communication module to provide basic vehicle information for the realization of information interaction between the vehicle and the outside world.

### 2. Communication Module

Referring to FIGS. 1 and 2, the communication module is responsible for integrating the vehicle data, positioning data and satellite time obtained in real time into the vehicle information, and sending to the outside world, and is also responsible for receiving the comprehensive information of the outside world, and sending to the main control unit.

Specifically, the communication module is an important communication module of the vehicle-mounted terminal, which can receive and send a large amount of real-time data, including the vehicle data (such as vehicle location, speed, direction and other information) and the comprehensive information (such as road construction, traffic congestion, accident warning and other information). The real-time data can be used by other vehicles, traffic management departments, smart city systems, etc., to achieve intelligent traffic management, autonomous driving and other functions. At the same time, the communication module can also support the connection between the vehicle and cloud services, and realize functions such as remote control, remote diagnosis, and software upgrade.

To be precise, the comprehensive information includes the information from other vehicles, infrastructure, pedestrians, and network devices. The communication module receives the vehicle data from the main control unit in real time, and integrates the vehicle data with the positioning data, the satellite time into the vehicle information, thereby sending to other vehicles, infrastructure, pedestrians and network equipment. At the same time, the communication module also receives the comprehensive information from other vehicles, infrastructure, pedestrians and network equipment in real time, and the received comprehensive information is fed back to the main control unit.

### 3. Power Management Module

Referring to FIGS. 1 and 2, the power management module is responsible for controlling the power management of the vehicle-mounted terminal, and controlling the sleep and wake-up of the vehicle-mounted terminal. Specifically, when the vehicle is turned off or not in use for a long time, the power management module can control the vehicle-mounted terminal to enter a dormant state to reduce energy consumption and extend the life of the equipment. When the vehicle starts or needs to use the vehicle-mounted terminal, the power management module can wake up the vehicle-mounted terminal to restore normal operation.

### 4. Security Chip Module

Referring to FIGS. 1 and 2, the security chip module is responsible for encrypting and decrypting communication data and performing security authentication on communication equipment to ensure the security of vehicle communications and data.

Specifically, the main function of the security chip module is to ensure the security of the vehicle communications and data, implement encryption and decryption of the communication data, and ensure the security of the data during transmission. At the same time, the security chip module can also realize the signature and verification of the vehicle data to ensure the authenticity and integrity of the data. In addition, the security chip module can also authenticate the vehicle communication equipment and the vehicle-mounted terminal equipment to ensure the legitimacy of the identities of both communicating parties. The security chip module has a strong encryption algorithm and security mechanism, which can effectively prevent hacker attacks and data leakage. At the same time, the security chip module can also provide a hardware-level security, including data storage, key management, digital signature, etc.

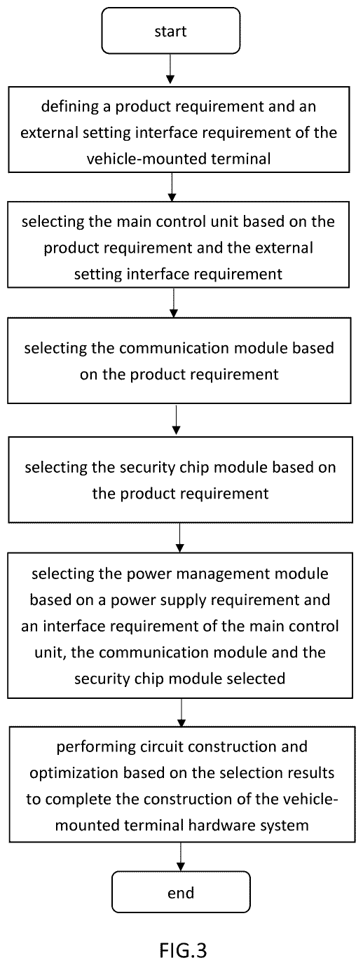

Second, based on the construction concept of the above four core parts, the construction method of the vehicle-mounted terminal hardware system can be further clarified. Referring to FIG. 3, the construction method includes the following steps:
S1: defining a product requirement and an external setting interface requirement of the vehicle-mounted terminal, wherein the step is clearly defined according to an actual requirement such as a vehicle model and a vehicle function.
S2. selecting the main control unit based on the product requirement and the external setting interface requirement determined in step S1. The main control unit usually selects a high-performance processor and/or MCU.
S3. selecting the communication module based on the product requirement determined in step S1.
S4. selecting the security chip module based on the product requirement determined in step S1.
S5: selecting the power management module based on a power supply requirement and an interface requirement of the main control unit, the communication module and the security chip module selected in steps S2-S4.
S6: performing circuit construction and optimization based on the selection results in steps S2 to S5 to complete the construction of the vehicle-mounted terminal hardware system.

In practical applications, a dedicated hardware system design platform for the vehicle-mounted terminal can be developed, which includes a chip database for the four core parts and a selecting algorithm logic for the four core parts. Developers only need to input the product requirement and the external setting interface requirement according to actual development conditions, and the design platform can automatically select models to obtain the best matching results to achieve generalized and integrated hardware design of vehicle-mounted terminal.

Third, in order to ensure that those skilled in the art can implement the concept of the present invention more easily, the detailed construction ideas of the above four core parts are further provided below:

### 1. Selection Requirements of the Main Control Unit

Referring to FIGS. 1 and 2, the main control unit generally uses a high-performance MCU and/or AP processor. As a preferred solution, in this embodiment, the main control unit includes an MCU module and an AP module interconnected, wherein:
(1) The work content of the MCU module includes: obtaining vehicle data from the CAN bus network, communicating with the whole vehicle controller and power management module to control the working states of the entire vehicle-mounted terminal and processing the vehicle data, the positioning data, and the specific external setting information;
(2) The work content of the AP module includes: providing an access path for a C-V2X application layer to enhance security and efficiency, serving as a forwarding channel for the relevant communication protocols to optimize communication performance with the communication module.

Referring to FIGS. 1 and 2, in order to ensure complete functions, the AP module has a first EMMC memory, a DDR memory, an SDMMC pin for external connection to a memory card, a USB-HOST pin for burning the program (i.e. the USB 2.0 HOST pin in FIG. 2), and a first Ethernet pin for debugging the network (i.e., the 100 Mbps Ethernet pin in FIG. 2), respectively arranged thereon.

### 2. Selection Requirements of the Communication Module

Referring to FIGS. 1 and 2, the communication module is preferably a 5G/C-V2X module. Specifically, the 5G/C-V2X module includes an LTE-V2X radio frequency circuit to realize the information interaction with other vehicles, infrastructure and pedestrians, and a 5G radio frequency circuit to realize the information interaction with network equipment. At the same time, the 5G/C-V2X module includes a USB interface to transmit information with the main control unit.

Referring to FIGS. 1 and 2, in order to ensure perfect functions, the communication module has a second EMMC memory and a second Ethernet pin for debugging the network (i.e. the Gigabit Ethernet pin in FIG. 2), respectively arranged thereon.

### 3. Circuit Construction of the Main Control Unit, the Communication Module and the Security Chip Module

Referring to FIGS. 1 and 2, the SPI pin of the communication module is connected and communicated with the SPI pin of the MCU module, which is used to transmit the CAN data information. The USB pin of the communication module is connected and communicated with the USB pin of the AP module, which is used to transmit the V2X data information. The SPI pin of the AP module is connected and communicated with the SPI pin of the security chip module, which is used to transmit the encrypted protocol data. The SPI pin of the AP module is connected and communicated with the SPI pin of the MCU module, which is used to transmit the CAN data information. The UART pin of the AP module is connected and communicated with the SPI pin of the MCU module, which is used to transmit the sleep and wake-up state information.

### 4. Other Constructions

Referring to FIGS. 1 and 2, in addition to the above four core parts, the vehicle-mounted terminal hardware system has a clock module and a positioning module. The clock module is electrically connected with the MCU module to provide the satellite time for the MCU module. The positioning module is electrically connected with the communication module to provide the positioning data for the communication module. In practical applications, the clock module and the positioning module can be integrated into other modules or constructed separately, without limitation.

Fourth, the following provides an intelligent vehicle-mounted terminal hardware system selection and development case of an autonomous vehicle based on the construction concept of the present invention:

### 1. Main Control Unit

### (1) The Functional Requirements of the Main Control Unit are as Follows:

\textcircled{1} With encryption function;
\textcircled{2} With external capacity expansion function for upgrade use;
\textcircled{3} With external industrial-grade network interface;
\textcircled{4} With external CAN expansion interface;

### (2) Selection of the Main Control Unit:

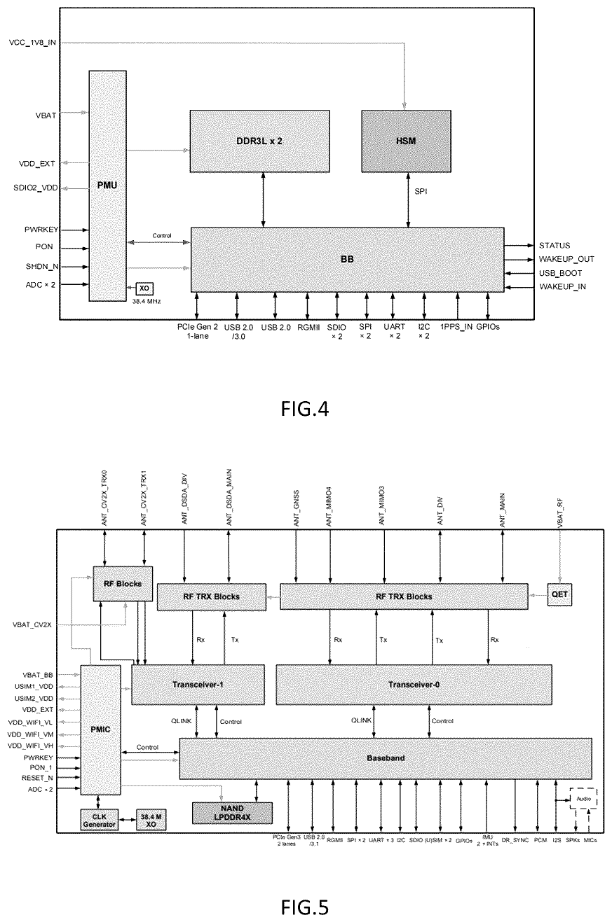

Referring to FIG. 4, the MCU module of the main control unit selects the S32K144HFT0VLLT chip, and the AP module selects the AG215S chip.

### (3) The Interface and Circuit Corresponding to the AG215S Chip:

\textcircled{1} The AG215S chip controls the security chip module through the SPI and 4 GPIO signals to achieve the encryption function;
\textcircled{2} The AG215S chip supports the SDIO interface, and the external TF cardholder is connected through the interface to achieve the storage capacity expansion function by connecting an external TF card;
\textcircled{3} The AG215S chip supports the RGMII interface, and the external network PHY is connected to achieve network communication function;
\textcircled{4} The CAN chip is connected through UART.

### (4) Selection Reasons and Advantages of the AG215S Chip:

Referring to FIG. 4, the AG215S chip has a powerful ARM core and a dedicated hardware encryption engine, which is an automotive-grade C-V2X application processor communication module for running ITS protocol stacks and applications. The AG215S series not only integrates a dedicated hardware acceleration engine to achieve powerful ECDSA verification functions, but also optimizes the communication performance with Quectel's automotive-grade LTE-A/5G modules.

### 2. Communication Module

### (1) the Functional Requirements of the Communication Module are as Follows:

\textcircled{1} 5G antenna X1, V2X antenna X1, GPS antenna X1;
\textcircled{2} External 232 expansion interface;
\textcircled{3} External WIFI module;
\textcircled{4} External industrial-grade network interface, external USB interface.

### (2) Selection of the Communication Module:

Referring to FIG. 5, the communication module selects the AG57XQ chip.

### (3) the Interface and Circuit Corresponding to the AG57XQ Chip:

\textcircled{1} The AG57XQ series supports four 5G antenna interfaces, two V2X antenna interfaces and one GNSS antenna interface, and the hardware circuit is reserved for interfaces;
\textcircled{2} The AG57XQ series supports three UARTs, one of which is reserved for the 232 interface chip;
\textcircled{3} The AG57XQ series supports one PCIE interface, which is reserved for the WIFI module chip to work;
\textcircled{4} The AG57XQ series supports one RGMII interface, which can be connected to an external network PHY for the communication function, and the chip supports two USB interfaces.

### (4) Selection Reasons and Advantages of the AG57XQ Chip:

Referring to FIG. 5, the AG57XQ chip is an automotive-grade 5G NR module, supports independent networking and non-independent networking modes, and is backward compatible with 4G/3G/2G networks. The AG57XQ chip supports multiple-input, multiple-output (MIMO) technology to meet the data rate and connection reliability requirements of the wireless communication system. The superior anti-electromagnetic interference capability of the AG57XQ chip meets the application needs of vehicle-mounted and other harsh environments.

### 3. Power Management Module

### (1) The Functional Requirements of the Power Management Module are as Follows:

Power supply to the main control unit, with 4 channels requiring high current and the other 8 channels requiring a maximum of 300 mA, and there are power-on timing requirements.

### (2) Selection of the Power Management Module:

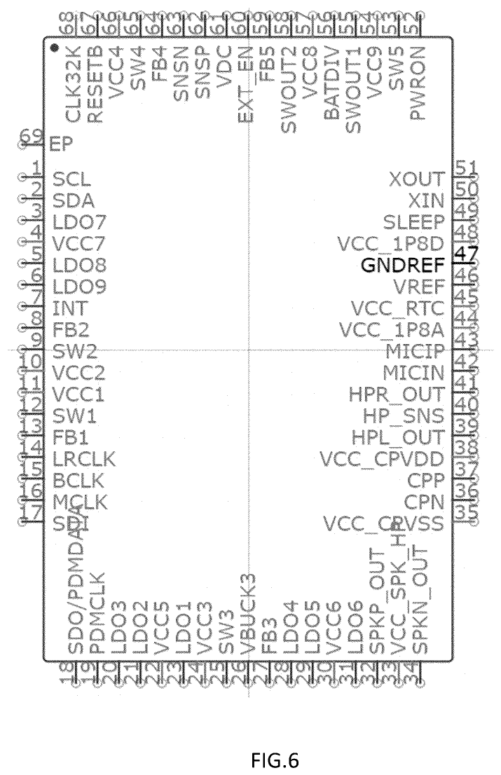

Referring to FIG. 6, the power management module selects the RK809 chip.

### (3) The Interface and Circuit Corresponding to the RK809 Chip:

The power chip includes four DC-DC channels and eight LDO channels. The power supply voltage is adjusted through MCU-12C programming.

### (4) Selection Reasons and Advantages of the RK809 Chip:

Referring to FIG. 6, Rockchip's RK809 chip is a highly integrated power management chip (PMIC) with few external components. RK809 internally integrates five configurable synchronous buck converters (DC/DC), nine LDO regulators, two switches, one RTC, and one high-performance CODEC. The MCU can adjust the power-on timing via the IIC pin.

### 4. Security Chip Module

### (1) The Functional Requirements of the Security Chip Module are as Follows:

It is used to store personal digital identity and user private information, and provide cryptographic services such as digital signature, signature verification, data encryption and decryption, and key management for mobile terminals, and is an intelligent security chip that meets the automotive-grade standards.

### (2) Selection of the Security Chip Module:

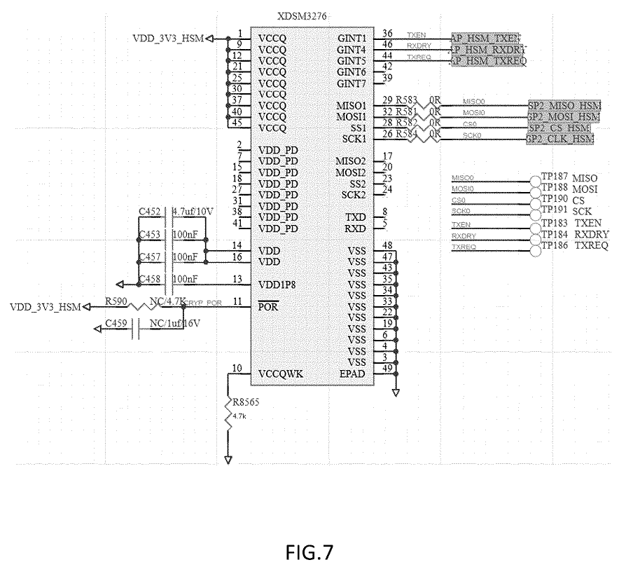

Referring to FIG. 7, the security chip module selects the XDSM3276 chip.

### (3) The Interface and Circuit Corresponding to the XDSM3276 Chip:

The hardware interface (SPI*2; UART; GPIO*5) of the XDSM3276 chip communicates with the main control unit through the SPI interface.

### (4) Selection Reasons and Advantages of the XDSM3276 Chip:

Referring to FIG. 7, the XDSM3276 chip is the industry's first automotive-grade high-performance security chip that meets the requirements of 5G-V2X application scenarios, and is used to solve the identity and communication security problems between vehicles and between vehicles and roads in the intelligent driving state. The chip has been innovated and optimized in accelerated cryptographic algorithms, low-power design, and physical security protection, and has the characteristics of high performance, high reliability, and low latency, and can achieve the security level of national cryptography. The XDSM3276's SM2 signature verification speed reaches 5,000 times/second, which meets the performance requirements of 2,000 times/second in various C-V2X application scenarios, and has been widely recognized and applied in the industry.

Fifth, the following describes in detail the differences and advantages of the V2X vehicle-mounted terminal construction method provided by the present invention compared with the conventional technology:

1. Compared with conventional vehicle-mounted terminals, the present invention mainly has the following differences:
(1) system architecture: the design method of the conventional vehicle-mounted terminal hardware system is usually customized for specific application scenarios, while the present invention adopts a modular and standardized system architecture, which allows better tailoring, combination, and splicing to achieve rapid development and meet the needs of different application scenarios.
(2) hardware platform: the conventional design method of the vehicle-mounted terminal hardware system adopts a relatively simple hardware platform, while the hardware construction provided by the present invention adopts a high-performance, low-power processor, such as a multi-core CPU. GPU, NPU, etc., to support complex computing tasks and multiple functions.
(3) interconnection and interoperability: the conventional design usually only supports limited communication protocols and interfaces, while the present invention focuses on the interconnection and interoperability between devices and supports multiple communication protocols and interfaces, such as 4G/5G, Wi-Fi, Bluetooth, USB, etc., to facilitate data interaction with other devices and cloud services.
(4) system security: the conventional hardware system design of vehicle-mounted terminals does not pay enough attention to system security, while the present invention attaches great importance to system security, including data security, network security and other aspects, and adopts a variety of security mechanisms to protect user privacy and data security.
   2. The beneficial technologies of the present invention compared with the conventional technology include the following:
1. good compatibility: the present invention adopts standard interfaces and protocols, which can achieve interconnection and interoperability with other devices and systems, and facilitate integration into different vehicles and application scenarios.
2. high flexibility: the present invention adopts modular construction methods, which can achieve flexible combination and expansion of different functional modules to meet the needs of different application scenarios.
3. miniaturization: the present invention adopts highly integrated chips and modules, which can realize small-sized devices that are convenient for installation and use.
4. high-performance: the present invention adopts highly integrated chips and modules, which can realize high-performance devices, improving data processing and communication capabilities.
5. low energy consumption: the present invention adopts integrated modules and efficient power management technology, which can realize low energy consumption of devices, prolonging the service life of devices.
6. low cost: the present invention adopts standardized and modular construction methods, which can achieve batch production of devices and cost reduction, benefiting promotion and application.

The above are only the specific embodiments of the present invention, but the design concept of the present invention is not limited thereto, and any non-substantial modification of the present invention by using this concept shall be an act of infringing the scope of protection of the present invention.

What is claimed is:

1. A V2X vehicle-mounted terminal construction method, wherein a vehicle-mounted terminal hardware system comprises a main control unit, a communication module, a power management module and a security chip module, respectively arranged thereon, wherein
(1) the main control unit is used to process the relevant communication protocols to realize an information interaction between the vehicle and the outside world, and is also used to receive and process a vehicle data and control a working status of a vehicle-mounted terminal, wherein the vehicle data comprises a whole vehicle controller information and a vehicle sensing equipment information;
(2) the communication module is used to integrate the vehicle data, a positioning data and a satellite time obtained in real time into a vehicle information and send the vehicle information to the outside world, and is also used to receive a comprehensive information from the outside world and send the comprehensive information to the main control unit, wherein the comprehensive information comprises an information from other vehicles, infrastructure, pedestrians and network equipment;
(3) the power management module is used to control a power management of the vehicle-mounted terminal and control a sleep and wake-up of the vehicle-mounted terminal;
(4) the security chip module is used to encrypt and decrypt a communication data and perform a security certification on the communication equipment, thereby ensuring the security of a vehicle communication and data;
the construction method comprises the following steps:
S1: defining a product requirement and an external setting interface requirement of the vehicle-mounted terminal;
S2. selecting the main control unit based on the product requirement and the external setting interface requirement determined in step S1;
S3. selecting the communication module based on the product requirement determined in step S1;
S4. selecting the security chip module based on the product requirement determined in step S1;
S5: selecting the power management module based on a power supply requirement and an interface requirement of the main control unit, the communication module and the security chip module selected in steps S2-S4; and
S6: performing circuit construction and optimization based on the selection results in steps S2 to S5 to complete the construction of the vehicle-mounted terminal hardware system.

2. The V2X vehicle-mounted terminal construction method, as recited in claim 1, wherein the communication module is a 5G/C-V2X module, wherein the 5G/C-V2X module comprises an LTE-V2X radio frequency circuit to realize the information interaction with other vehicles, infrastructure and pedestrians, and a 5G radio frequency circuit to realize the information interaction with network equipment.

3. The V2X vehicle-mounted terminal construction method, as recited in claim 1, wherein the main control unit comprises an MCU module and an AP module interconnected, wherein
the work content of the MCU module comprises obtaining the vehicle data from a CAN bus network, communicating with a whole vehicle controller and the power management module to control the working states of the entire vehicle-mounted terminal and processing the vehicle data, the positioning data, and a specific external setting information, wherein
the work content of the AP module comprises providing an access path for a C-V2X application layer to enhance security and efficiency and serving as a forwarding channel for the relevant communication protocols to optimize the communication performance with the communication module.

4. The V2X vehicle-mounted terminal construction method, as recited in claim 3, wherein the SPI pin of the communication module is connected and communicated with the SPI pin of the MCU module, which is used to transmit the CAN data information, wherein the USB pin of the communication module is connected and communicated with the USB pin of the AP module, which is used to transmit the V2X data information, wherein the SPI pin of the AP module is connected and communicated with the SPI pin of the security chip module, which is used to transmit the encrypted protocol data, wherein the SPI pin of the AP module is connected and communicated with the SPI pin of the MCU module, which is used to transmit the CAN data information, wherein the UART pin of the AP module is connected and communicated with the SPI pin of the MCU module, which is used to transmit the sleep and wake-up state information.

5. The V2X vehicle-mounted terminal construction method, as recited in claim 3, wherein the vehicle-mounted terminal hardware system further comprises a clock module and a positioning module, wherein the clock module is electrically connected with the MCU module to provide the satellite time for the MCU module, wherein the positioning module is electrically connected with the communication module to provide the positioning data for the communication module.

6. The V2X vehicle-mounted terminal construction method, as recited in claim 3, wherein the AP module has a first EMMC memory, a DDR memory, an SDMMC pin for external connection to a memory card, a USB-HOST pin for burning the program, and a first Ethernet pin for debugging the network, respectively arranged thereon.

7. The V2X vehicle-mounted terminal construction method, as recited in claim 2, wherein the communication module has a second EMMC memory and a second Ethernet pin for debugging the network, respectively arranged thereon.

8. The V2X vehicle-mounted terminal construction method, as recited in claim 3, wherein the MCU module selects the S32K144HFT0VLLT chip, and the AP module selects the AG215S chip.

9. The V2X vehicle-mounted terminal construction method, as recited in claim 2,
wherein the communication module selects the AG57XQ chip.

10. The V2X vehicle-mounted terminal construction method, as recited in claim 1, wherein the security chip module uses the XDSM3276 chip.
